(19) United States
(12) Patent Application Publication
(10) Pub. No.: US 2008/0178488 A1
(43) Pub. Date: Jul. 31, 2008

(54) Portable counter flow drying and highly efficient grain drier with integrated heat recovery

(76) Inventor: Steve D. Shivvers, Prole, IA (US)

Correspondence Address: LAW OFFICE OF JOHN C. MCMAHON, P.O. BOX 30069, KANSAS CITY, MO, 64112, US

(21) Appl. No.: 11/986,738

(22) Filed: Nov. 26, 2007

Related U.S. Application Data
(60) Provisional application No. 60/897,731, filed on Jan. 26, 2007.

(51) Int. Cl. F26B 17/12

(52) U.S. Cl. 34/169

(57) ABSTRACT

A drier for particulate material including upper, intermediate, and lower regions. The material to be dried is flowed through the regions while a fluid, preferably ambient air, is counterflowed to the material through the lower and then upper regions, but not the intermediate region, such that the fluid cools and dries the material in the lower region and preheats the material in the upper region. The material is further heated by a makeup heater in the intermediate region to a preselected temperature.

### CROSS REFERENCE TO RELATED APPLICATIONS

This application claims the benefit of U.S. Provisional Application No. 60/897,731, filed Jan. 26, 2007 which is incorporated herein by reference.

### STATEMENT REGARDING UNITED STATES GOVERNMENT SPONSORED RESEARCH OR DEVELOPMENT

The present invention was at least in part made with support from the United States Government under Contract No. 2005-33610-15517 awarded by the USDA SBIR. The United States Government has certain rights in the invention.

### BACKGROUND OF THE INVENTION

The present invention is directed to improvements in driers of grains and other materials and methods of drying and, in particular, to driers that recover and utilize a comparatively high percentage of the energy used in the drying process.

The drying industry is very large and utilizes significant amounts of both fossil fuels and electricity to dry various materials. While the grain industry is not the only industry that requires significant drying, it is indicative of the problems that exist. Just the U.S. corn crop amounts to over nine billion bushels annually. Moisture must be removed in order to allow the grain to be stored without significant loss due to mold, mildew and rot caused by excess retained moisture.

In theory, each pound of water removed from the grain has a latent heat of vaporization of about 1160 British thermal units (Btu's). In a highly effective dryer system, the dryer could import exactly this theoretical amount of energy per pound of water to be removed from the grain. In reality, the grain also takes on sensible heat which increases the temperature of the grain, the flow of heating gas is not uniform, the grain is often heated more on one side of the dryer than the other, much of the added heat is exhausted into the air after one pass through the drier, etc., such that the efficiency of all types of conventional driers is comparatively low. Cross flow grain driers normally require approximately 2800 Btu per pound of water removed versus the theoretical amount of 1160 Btu per pound.

Because the corn industry in the U.S. consumes approximately 900 million gallons of propane and over 3200 million kilowatt-hours of electricity per year just to dry the corn and because this produces nearly two million tons of carbon dioxide exhaust gases per year, it is seen that any improvement in drying efficiency can amount to significant savings in fuel, energy and emissions. Corn is only one type of grain that must be dried. Further, there are many other solids, semi-solids and initially liquid compositions that are dried each year at considerable costs in terms of fuel, energy and undesired emissions due to combustion of the fuels.

It is further noted that for some materials the manner of drying is important to prevent excessive shock to the product being dried and/or to reduce inconsistency in the dried material. For example, grain kernels can be cracked by cooling or heating too quickly, which can lead to degradation of the grain. While conventional driers may produce a selected average moisture content in the dried product, the moisture content may not be consistent throughout. Consequently, problems are encountered in many types of conventional cross flow driers for grain where the grain is heated and dried by air passing perpendicularly to the flow of the grain. In such driers, the grain on one side of the drier that first encounters the heated air is overly dried and may be dried too quickly or cooled too quickly so as to cause cracking and the grain on the opposite or air discharge side tends to be too wet. Therefore, it is also desirable to provide a drier that provides consistent, uniform and non stressful heating to drive off moisture and thereafter uniform and non stressful cooling.

In some circumstances, it is also desirable to provide a closed recycle system for gas used in the drying process to reduce dust or other undesirable emissions.

### SUMMARY OF THE INVENTION

A drier for drying grain and similar granular or particulate materials which in comparison to conventional drying processes has a high efficiency with respect to the added heat required to remove a desired percentage of moisture from the grain. Preferably, the material to be dried by the present invention does not quickly absorb additional moisture. A good material to be dried by the invention is corn. In particular, corn has an external skin or covering that allows the relatively gradual migration of moisture to the surface from the interior and then the evaporation of the moisture from the surface, but which does not quickly reabsorb moisture that may be condensed onto its exterior surface which occurs in certain embodiments of the present invention.

The drier has a lower region wherein grain is downflowed through a chamber, whereas air at ambient temperature or another cooling and drying fluid is overall counterflowed through the grain in the lower region. The grain first enters the dryer in an upper region and is comparatively wet and cool. The air that has been counterflowed through the lower region, is counter flowed through the grain in the upper region such that grain exiting the upper region is comparatively warmer than when entering the upper region. The air in the upper region becomes cooled and the moisture therein at least partially condenses and is removed from the grain in the upper region.

The air between exiting the lower section and entering the upper section is bypassed around the grain in an intermediate region wherein the grain is passed through a makeup heater to add makeup heat lost in the process to bring the temperature of the grain entering the lower region to a preselected level.

The drier of the invention is designed to be transportable in large sections from a site of manufacture to a site of usage and is usable in conjunction with storage bins in place on a farm or other location. The drier is easily assembled and disassembled into parts suitable for transport on a single truck.

### OBJECTS AND ADVANTAGES OF THE INVENTION

Therefore, the objects of the present invention are: to provide a drier for drying grain and similar particulate material with a comparatively high efficiency with respect to usage of heat provided to the system; to provide such a drier having an upper region for flowing air that is warm and wet through the grain to heat the grain, thereafter, transferring the grain to a makeup heating region that is bypassed by the air to further heat the grain, and further to then flow the heated grain through a lower region counterflow to initially ambient air so that the air comparatively becomes hot and wet and is conveyed to the upper region while the grain becomes cooler and dryer in comparison to the original moisture level of the grain; to provide such a drier wherein the drier can be easily transported from one site to another, such as from a site of manufacture to a site of usage; and to provide such a drier that is easy to use, highly efficient in usage of heat to obtain a desired level of drying and especially well adapted for the intended use thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a drier in accordance with the present invention in conjunction with a pair of grain storage bins.

FIG. 2 is an enlarged and partially schematic cross sectional view of the drier, taken along line 2-2 of FIG. 1.

FIG. 3 is a perspective view of a truck with the drier located thereon in a disassembled configuration.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference numeral 1 generally designates a drier that is operatively used to dry a material, such as the illustrated grain 2, such as corn, or other wet granular or particulate material. The grain 2 is schematically shown by crosshatching shading within the drier 1.

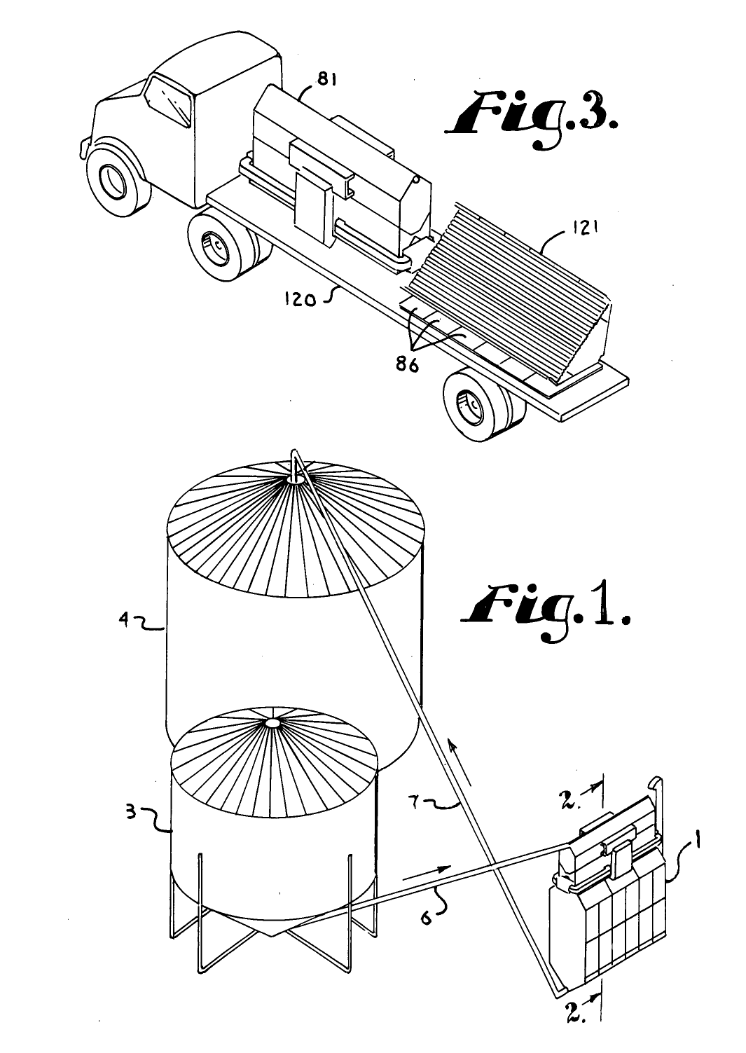

In FIG. 1, the drier 1 is utilized in conjunction with a first wet grain storage bin 3 and a second dry grain storage bin 4. The bin 3 is flow connected to the drier 1 by a transfer or feed conveying tube 6 and the bin 4 is flow connected to the drier 1 by a discharge conveying tube 7. Grain 2 is moved through the tubes 6 and 7 by conventional devices which may include blowers, augers or the like (not shown).

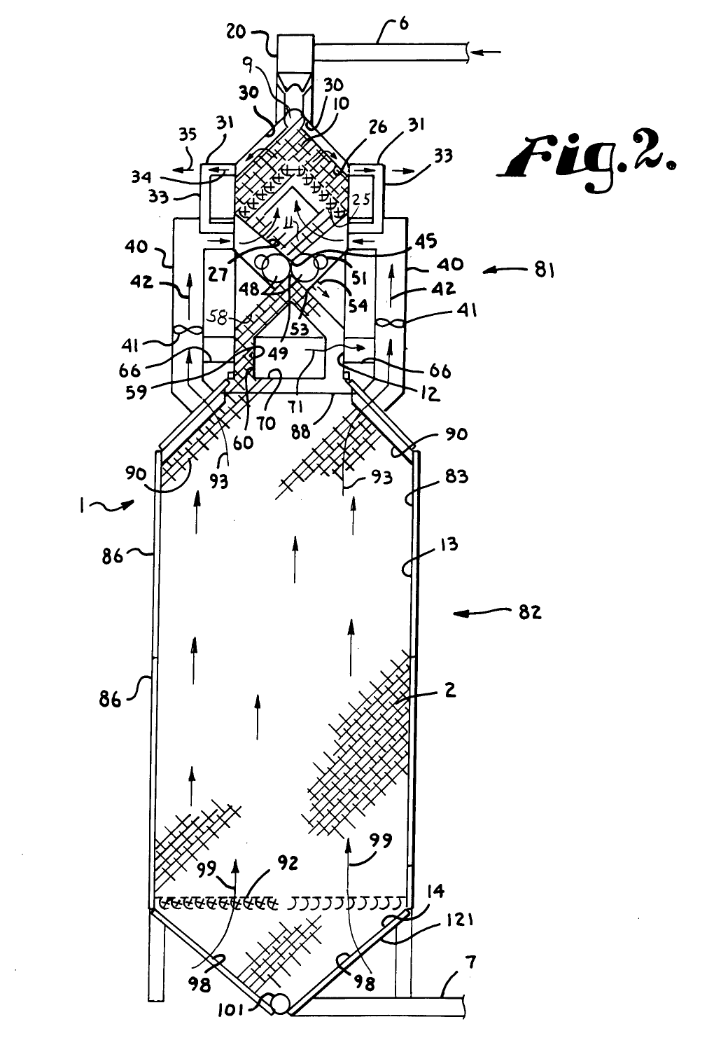

As seen in FIG. 2, the drier 1 includes a wet grain feeder 9, an upper wet grain feed region 10, a wet grain and hot fluid mixing region 11 that also serves as a near counter current flow heat transfer zone, extracting sensible and latent heat from the hot fluid 42 and transferring it to the grain 2, an intermediate makeup heating region 12, a lower grain cooling and grain moisture releasing region 13 and a dry grain collection region 14.

Beginning at the top of the dryer 1, the grain conveying tube 6 conveys or delivers the grain 2 to a chute 20. The grain 2 falls through the chute 20 due to gravity into the wet grain fed region 10 from which the grain 2 is fed into the region 11 by gravity flow and the grain 2 is fed into the region 11 by metering rollers 25. An upper wall 26 of the region 10 and a lower wall 27 of the region 11 are perforated so as to allow passage of a fluid, preferably and here ambient or recycled air therethrough, although it is foreseen that other fluids could be used within the invention. The air represented by arrows within the drier 1 flows through the upper wall 26 and is collected in a plenum or channels 30 that flow connect with a discharge tube 31 for discharging the air after usage in the drier 1 into the atmosphere. The discharge tube 31 can be bypassed during startup to recycle the air through a recirculation channel 33 under control of valving (not shown). The air is passed through a startup preheater (not shown). This enables initial preheating of the grain 2 during start up of the drying process. During normal operation, air flows through the tubes 31 as shown by arrows 34 and 35.

As will be discussed below further, the air in a comparatively hot and saturated state passes through the lower wall 27 and into the region 11 from bypass conduits 40 located on opposite sides of the drier 1. The air is driven through the conduits 40, as indicated by arrows 42, as well as the remainder of the drier 1 by fans 41 located within the conduits 40. The upper wall 26 and lower wall 27 are perforated with sufficiently large apertures to allow flow of the air, but the apertures are sufficiently small to prevent passage of the grain 2 therethrough. The size of the apertures may be required to be varied in accordance with the particulate size of the grain 2 or other material being dried.

The lower walls 27 join at a lower slot 45 which opens into a pair of sponge rollers 48 which depress sufficiently to allow passage of grain 2 therethrough, without damaging the grain 2, while forming an airlock 49. A pair of squeegee rollers 51 operably abut against the rollers 48 and squeeze water therefrom which collects at low point or trap 53 and is discharged at an outlet 54.

Beneath the rollers 48 is a pair of crossing channels 58 which feed the grain 2 downwardly. The lower portions 59 of the channels 58 are also perforated to allow passage of air through the sides thereof, but prevent passage of grain therethrough. A makeup heater 70 is located between the channels 59 in an intermediate region 60 of the drier 1. Air is passed though the heater 70 and passes through the channels 59 and into side conduits 66 as represented by the squiggle arrow 71. Air from the conduits 66 is fed into the inlet of the heater 70. In this manner, the air from the conduits 40 heats the grain in regions 10 and 11 and then any additional heat required for the grain 2 to reach a preselected temperature at the bottom of the channels 59 is supplied by the makeup heater 70. It is noted that the air that enters regions 10 and 11 from the conduits 40 is comparatively warm and saturated or, at least partially saturated, with moisture. As the air in the regions 10 and 11 directly engages and transfers heat by conduction to the grain 2 therein so as to heat the grain, the air in the regions 10 and 11 cools and at least part of the moisture therein condensates. This condensate is the water that collects at the traps 53 and is discharged at the outlet 54.

The above described portion of the drier 1 is the head portion 81. A lower portion or body 82 of the drier effectively provides a comparatively large holding area 83 for the grain 2. The holding area 83 is formed by a plurality of panels 86 so as to produce an enclosure for the holding area 83. The channels 59 discharge comparatively hot grain 2 into a top 88 of the holding area 83. Located to either side of the top 88 are perforated walls 90. Air passes through the walls 90 and is collected in the conduits 40, as indicated by the arrows 93. The perforations in the walls 90 are sized to allow passage of air, but not of the grain 2.

The lower end of the body 82 includes a V-shaped collection area that forms the region 14. Grain 2 is metered from the region 13 to the region 14 under control of a series of metering rollers 92. The region 14 has exterior side walls 98 that are perforated so as to allow passage of air therethrough, but not grain 2, as is indicated by the arrows 99. In this manner, air is drawn through the walls 98 and upward through the grain 2 in the regions 13 and 14 and into the conduits 40. The air entering the region 14 is at ambient temperature and comparatively cool relative to the grain 2 at the body top 88. As the air passes upward through the grain 2 in regions 13 and 14, the air becomes warmer and at least partially saturated with moisture that is driven from the grain 2 due to the grain 2 being hot and by the air initially being less than saturated. The grain 2 passing downward through the body becomes comparatively cooler and dryer. The grain 2 exits the bottom of the body 82 at a discharge 101 into the transfer tube 7.

During startup of the drier 1, it is necessary to heat the grain before cooling air is passed through the grain. This is done by feeding grain 2 through the region 10 with the discharge tube 31 bypassed and a startup preheater (not shown) engaged and also through the heater 70 and allowing the heated grain 2 to generally fill the region 13 before starting the fans 41.

In some situations where emissions may be a problem, it is foreseen that conduits may be provided so that the air discharge from the tubes 31 is joined with the bottom of the body 82 and thus the air is recycled. A cooler or chiller may also be required in such a recycle conduit to lower the temperature and/or the dewpoint of the recycled air. When a chiller is utilized in this manner, condensate is collected and discharged from the chiller so as to reduce the amount of moisture in the recycled fluid.

Thus, the air preferably enters the drier 1 at the bottom of region 14 and passes upward through the regions 13 and 14 in direct heat transfer contact with the grain 2 therein. At the top 88 of region 13, the air is comparatively hot and wet. The grain 2 at the top 88 of the body 82 is comparatively hot and wet. The air entering region 14 is comparatively cool and dry and the grain 2 at the discharge 101 is comparatively dryer than the grain 2 entering the region 10. The grain 2 in the regions 10 and 11 is heated by the air bypassing the makeup heater 70 through the conduits 40. Thereafter, the grain from the region 11 is further heated by the makeup heater 70 to a preselected temperature to enter the body 82.

Typically, one pass through the drier 1 will result in a step decrease in moisture, for example, of 4 percent in the form of water of the weight of the initial wet grain, but in some instances may completely remove all moisture from the material to be dried. This varies somewhat depending on outside air humidity, the size and shape of the drier 1 and the type of grain to be dried. If it is desired to remove more moisture, the grain can be passed again through the drier 1 for the number of times necessary to reduce the moisture level to the desired level.

As can be seen in FIG. 3, the drier 1 can be disassembled to be placed on a truck 120, so as to be transported between sites of manufacture and use. The head portion 81 can be loaded as a unit. Likewise, the lower end 121 of the body 82 formed between the walls 98 and the metering rolls 92 is loaded as a unit. The panels 86 forming the remainder of the body 82 are at least partially separated from one another and laid flat on the truck 120 for transport beneath the lower end 121, so that the entire drier 1 can be transported by a single truck 120.

It is foreseen that an air moving device, such as the fans 41 could be located at different locations with the same or similar result to either drive or pull the air through the device.

It is also foreseen that makeup heat could be applied in other ways than as illustrated and described. For example, the air entering region 11 could be further heated by a makeup heater or the grain could be preheated prior to entering the drier 1. Also, in some instances, the flow of air through the regions 10, 11, 13 and 14 may be at least partly other than strictly counterflow relative to the grain. In particular, the air could be cross flowed relative to the grain in certain circumstances. In some instances the drier may be divided into multiple sections and the flow in each section could be selected from counterflow, cross flow, concurrent flow, or mixed flow (combinations of these) with overall flow being generally countercurrent.

It is foreseen that other types of driers besides the described vertical column and including rotary chamber driers could be used in the process in accordance with the invention.

While air and nitrogen are the most likely fluids to be used in a process of this type, it is foreseen that other fluids such as argon or the like may be used. Furthermore, while particular materials to be dried have been mentioned herein, it is foreseen that a wide variety of materials may be dried, including particulates and other granular materials, powders, flakes and solids in general. Such materials are not restricted to but may be represented by foodstuffs, such as grains, beans, dog food, mixes, meals and flours; chemicals such as clays, coals, sand; and processed materials, such as paper and the like.

It is foreseen that the drier 1 can be operated under vacuum or pressurized in certain embodiments.

It is to be understood that while certain forms of the present invention have been illustrated and described herein, it is not to be limited to the specific forms or arrangement of parts described and shown.

What is claimed and desired to be secured by Letters Patent is as follows:

1. A drier for removing moisture from particulate material comprising:
a) an upper region for operably initially receiving the material;
b) an intermediate region with a makeup heater for heating the particulate material and operably receiving the particulate material from the upper region;
c) a lower region operably receiving the particulate material from the intermediate region and operably allowing the particulate material to pass downwardly therethrough;
d) a fluid circulation system for overall generally counterflowing fluid through said lower region and then said upper region while bypassing said intermediate region; and
e) a fluid driver for operably conveying said fluid through said fluid circulation system.

2. The drier according to claim 1 wherein:
a) the fluid is ambient air; and
b) the fluid driver is a fan.

3. The drier according to claim 1 wherein:
a) said upper and intermediate regions are disassembled as a unit and said lower region includes a foot section and a plurality of disassembled panels to allow said drier to be transported between at least two spaced sites.

4. A method of drying a particulate material comprising the steps of:
a) providing a drier with first, second and third regions;
b) conveying the material sequentially through the first, second and third regions;
c) heating said material in the first and second regions to a preselected temperature range above an original temperature of the material;
d) conveying a fluid, originally cooler than the material entering the third region, so as to pass through the material initially in the third region and thereafter in the first region while bypassing the second region such that the fluid becomes comparatively warmer and comparatively saturated with moisture as the fluid passes through the third region while the material becomes dryer and cooler as the material passes through the third region and such that the fluid becomes cooler during passage through the first region and the material in the first region becomes warmer as the material passes through the first region; and
e) further heating the material in the second region to the preselected temperature range.

5. The method according to claim 4 including the steps of:
a) passing the fluid overall generally countercurrent to the material in the first and third regions.

6. The method according to claim 4 wherein:
a) said fluid is air.

7. The method according to claim 4 including the steps of:
a) recirculating said fluid from an exit of said first region to the inlet of said third region.

8. The method according to claim 7 including the step of:
a) cooling the fluid during recirculation between the first and third regions.

9. A drier for removing moisture from particulate material comprising:
a) an upper region for operably initially receiving the particulate material in the upper portion thereof and for operably warming the received material by generally counter current flow of a fluid relative to a flow of the particulate material;
b) an intermediate region with a makeup heater for heating the material and operably receiving the particulate material from the upper region;
c) a lower region operably receiving the particulate material from the intermediate region and operably allowing the material to flow therethrough generally counter current to said fluid;
d) a fluid circulation system for overall generally counterflowing fluid sequentially through said lower region and then said upper region while bypassing said intermediate region; and
e) a fluid driver for operably conveying said fluid through said fluid circulation system.

10. The drier according to claim 9 wherein:
a) the fluid is ambient air; and
b) the fluid driver is a fan.

11. The drier according to claim 9 wherein:
a) said upper and intermediate regions are initially assembled as a unit and said lower region includes a foot section and a plurality of non integral and originally loose panels to allow said drier to be transported between at least two spaced sites.

12. A drier for removing moisture from particulate material comprising:
a) an upper region for operably initially receiving the particulate material in the upper portion thereof and for operably warming the received material by generally counter current flow of a fluid relative to the flow of the particulate material;
b) a condensate/particulate material separation mechanism for operably removing condensate from the particulate material;
c) an intermediate region with a makeup heater for heating the material and operably receiving the particulate material from the upper region;
d) a lower region operably receiving the particulate material from the intermediate region and operably allowing the material to pass downwardly therethrough;
e) a fluid circulation system for generally counterflowing the fluid sequentially through the particulate material in said lower region and then the upper region while bypassing said intermediate region; and
f) a fluid driver for operably conveying said fluid through the fluid circulation system.

13. The drier according to claim 12 wherein:
a) the fluid is ambient air; and
b) the fluid driver is a fan.

14. The drier according to claim 12 wherein:
a) said upper and intermediate regions are assembled as a unit and said lower region includes a foot section and a plurality of initially loose panels to allow said drier to be transported between at least two spaced sites.

15. A drier for removing moisture from particulate material comprising:
a) an upper region for operably initially receiving the particulate material in the upper portion thereof and for operably warming the received material by generally counter current flow of a fluid relative to the flow of the particulate material in the upper region;
b) a condensate/particulate material separation mechanism for operably removing condensate from said particulate material in said upper region;
c) an intermediate region with a makeup heater for heating the material and operably receiving the grain from the upper region;
d) a lower region operably receiving the particulate material from the intermediate region and operably allowing the material to pass downwardly therethrough;
e) a fluid circulation system for generally overall counterflowing the fluid relative to the flow of particulate material through said lower region and then the upper region while bypassing said intermediate region; and
f) a fluid driver for operably conveying said fluid through the fluid circulation system.

16. The drier according to claim 15 wherein:
a) the fluid is ambient air; and
b) the fluid driver is a fan.

17. The drier according to claim 15 wherein:
a) said upper and intermediate regions are assembled as a unit and said lower region includes a foot section and a plurality of initially loose panels to allow the drier to be transported between at least two spaced sites.

18. The drier according to claim 15 wherein:
a) a heating mechanism is provided for operably preheating the particulate material upon initial startup of the system to a preselected temperature; and
b) the preheated material is allowed to flow downward and fill the lower region upon initial startup of the system.

19. A method of drying a particulate material comprising the steps of:
a) providing a drier with first, second, and third regions;
b) conveying the material sequentially through said first and third regions while bypassing said second region;
c) heating said material in said first region to a pre-selected temperature above the original temperature of the material;
d) conveying a fluid, originally cooler than the material and entering said third region, through the material in the third region such that said fluid becomes comparatively warmer and comparatively saturated with moisture as said fluid passes through the third region while the material becomes dryer and cooler as the material passes through the third region;
e) subsequent to step d conveying the fluid between said first and said third region, while adding make up heat to said fluid as it passes between said first and third regions; and
f) subsequent to step e conveying the fluid through the material in first region, such that the fluid becomes cooler during passage through the first region and the material in said first region becomes warmer as the material passes through the first region.

20. The method according to claim 20 including the step of:
a) passing the fluid generally overall countercurrent through the material in the first and third regions.

21. The method according to claim 19 wherein:
a) said fluid is air.

22. The method according to claim 19 including the steps of:
a) recirculating the fluid from an exit of the first region to the inlet of the third region.

23. The method according to claim 22 including the step of:
a) cooling the fluid during recirculation between the first and third regions.
